(19) United States
(12) Patent Application Publication
(10) Pub. No.: US 2004/0151428 A1
(43) Pub. Date: Aug. 5, 2004

(54) Amplified optical splitter

(76) Inventor: Dmitri E. Nikonov, San Jose, CA (US)

Correspondence Address: Timothy N. Trop, TROP, PRUNER & HU, P.C., 8554 KATY FWY, STE 100, HOUSTON, TX, 77024-1841, US

(21) Appl. No.: 10/354,408

(22) Filed: Jan. 30, 2003

(51) Int. Cl. G02B 6/26

(52) U.S. Cl. 385/27; 385/15; 385/39; 385/42

(57) ABSTRACT

An optical power splitter may include an optical amplifier and a combiner to combine pump laser power with an input optical signal. The combined signal is then split. The split signal may then be passed to a waveguide amplifier.

### BACKGROUND

This invention relates generally to optical networks and, particularly, optical networks that use optical amplifiers and optical power splitters.

In the optical network, a signal may be transmitted over an optical fiber. The signal may include a plurality of channels, each of a different wavelength. In order to multiplex the different channels onto the fiber, a multiplexer may be used. A demultiplexer is used to separate out the multiplexed channels at a destination.

An alternative to a multiplexer is a power splitter, which divides each of the channels equally among its outputs, followed at each output by a filter, which selects only one channel. In other cases, a signal, containing a single channel or multiple channels, may be split by a splitter and delivered to several different destinations. Currently, splitters are standalone devices formed of fused fiber couplers or planar waveguide circuits.

Amplification is required to compensate for propagation losses and loss of power of the signal due to splitting. Amplification of the optical signal is usually provided by erbium-doped fiber amplifiers. These amplifiers are too expensive for wide deployment in access networks.

Waveguide erbium-doped amplifiers are formed as planar waveguide circuits. These amplifiers can be made as arrays of amplifiers giving great advantage to amplifying the multiple signals: either after the signal is demultiplexed into separate wavelength channels or split into several outputs. Optical waveguide amplifiers may be advantageous because the input power in this case is lower and, therefore, the gain medium is further from saturation. As a result, the gain is correspondingly higher.

These waveguide amplifiers include one or more laser pumps, for example, at wavelengths around 980 nanometers or 1480 nanometers. The pump lasers are the most expensive part of amplifiers and the price increases with increased pump laser power. Therefore, it is desirable to share the pump between several different amplifiers. Currently, a separate pump distribution network, in which a separate device coupled to an amplifier array, may be used.

Thus, a fiber carrying an input signal is coupled to the splitter and the pump and the pump distribution network is connected to the amplifier by way of optical fibers. The outputs from the splitters are coupled to the inputs of the amplifiers by fibers as well. The waveguide circuit may be used as a pump distribution network. Multiple fiber interfaces and waveguide splitters introduce unnecessary insertion power loss. Splicing multiple fiber connections and testing the resulting device is very tedious and expensive.

Thus, there is a need for better ways to construct amplified splitters.

### BRIEF DESCRIPTION OF THE DRAWINGS

FIG. 1 is a schematic depiction of one embodiment of the present invention; and

FIG. 2 is a depiction of an amplified splitter in accordance with one embodiment of the present invention.

### DETAILED DESCRIPTION

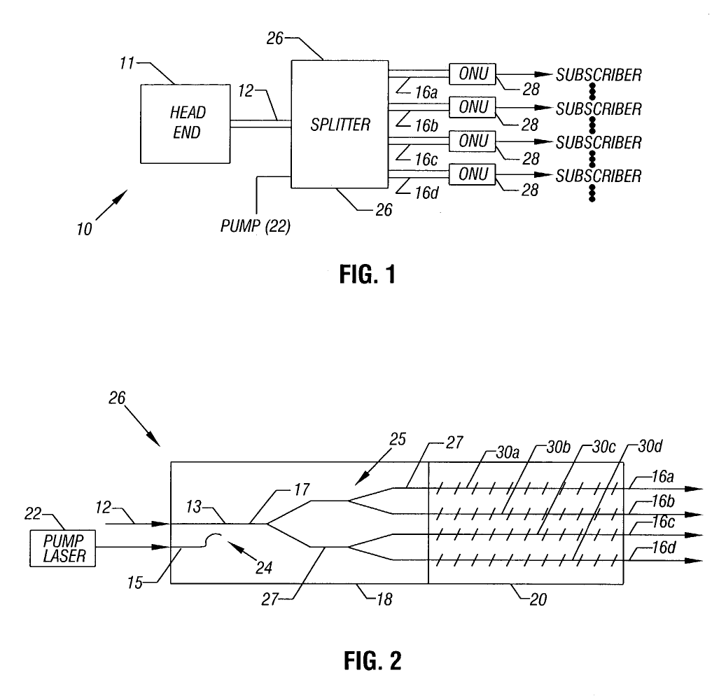

Referring to FIG. 1, an optical access network 10 may have a central office or head end 11 providing an initial optical signal 12, over a fiber or other medium, to a splitter 26 in order to form output signals 16a, 16b, 16c, and 16d in this example. In one embodiment, the splitter 26 may be a passive optical splitter (POS). Each output signal 16 may proceed to an optical node unit (ONU) 28, in one embodiment, that, in turn, may be coupled to a large number of subscribers.

In one embodiment, each ONU 28 transmits and receives an independent optical channel to provide subscribers with dynamically allocated voice, data, and video bandwidth. Thus, it can be appreciated that the signal from the head end 11 may be transmitted over the network 10 and, as needed, desired channels can be split off using a splitter 26 at locations where those signals are desired.

Several of the outputs 16 from the splitter 26 may be delivered to the destinations, such as the ONU 28. It is possible that one or more of these outputs 16 is split and amplified again to broadcast the initial signal to more destinations.

The splitter 26 is shown in more detail in FIG. 2. It includes a splitter section 18 and an integrated waveguide amplifier section 20. The initial optical signal 12 goes to the splitter 26 where, in this example, it is split into four identical output signals 16. The waveguide amplifier section 20 contains an array of amplifiers 30, one for each split output signal 16 in this example. Each of the outputs of the splitter section 18 is coupled to an input of one of the arrayed amplifiers 30. The sections 18 and 20 may be a single waveguide circuit manufactured on a single substrate or two separate waveguide circuits manufactured on different substrates and then coupled together.

Each of the amplifiers 30 in the section 20 may have pump laser light transferred into its waveguide. Due to the high cost of the pump lasers and overwhelming complexity of packaging several pump lasers, usually a single pump laser is distributed among the amplifiers. In the commercial practice in the field, a separate device, connected with fibers, is used to distribute the pump laser light.

The light from the pump laser 22 and the initial optical signal 12 are combined in the same waveguide 13 before being split. Then the same splitter section 18 is used to split both the input optical signal 12 (which may be single or multiple wavelength channels) and the pump 22 signal into several identical parts. Each of these parts is directed to a waveguide amplifier 30 of the amplifier section 20. Then the gain medium in each of the amplifier 30 is excited by the light originating in pump 22. In one embodiment this gain medium can be a waveguide material doped with rare-earth ions. In one embodiment, the ions are of erbium. The pump light and the input optical signal are thus split by the same splitter and the amplification is happening in each amplifier 30 through the transfer of energy from the pump to the signal light.

As shown in FIG. 2, pump 22 laser light and the input optical signal 12 may be combined in a combiner 24. In one embodiment, the combiner 24 may be a waveguide directional coupler. A directional coupler is a device, typically consisting of two waveguides, in which optical fields propagating in the same direction can be transferred from one waveguide to another due to evanescent coupling of optical modes in said waveguides. If the light is entering the coupler in the top waveguide 13, an amount of its power will be transferred to the bottom waveguide 15 and vice versa. This power transfer amount depends on the length of the coupler 24, the wavelength of light, and the separation between waveguides 13 and 15. The coupler 24 is designed such that the input optical signal 12 and pump 22 signal get transferred into the same waveguide 17, which is the input to the splitter unit 25.

In one embodiment, the splitter unit 25 is constructed as a set of cascaded Y-branches 27. In a Y-branch 27, a light from one waveguide is split into two waveguides.

In another embodiment, the splitter unit 25 is constructed as a slab star coupler. In a star coupler, the light from one waveguide is allowed to spread in a slab region and then simultaneously coupled to a set of waveguides on the other side of the slab.

In one embodiment, the splitter unit 25 splits the input light uniformly between the channels regardless of the wavelength. This condition ensures that both the input optical signal 12 and the pump 22 signal, which have different wavelengths, will be properly split.

Thus, the input optical signal 12 from the head end 11 may be at one wavelength while the signal from the pump 22 may be at a different wavelength. In addition, both the input optical signal 12 and the pump 22 signal may have different power.

After combination by the combiner 24, the input optical signal 12 and the pump 22 signal may still have their same power. However, after splitting in the branches 27 of the splitter unit 25, the pump 22 signal then has a power which is spread over a plurality of branches 27 resulting in a commensurate reduction in power of the pump signal portion on each branch 27. Likewise, the power of the input optical signal 12 is split among the various branches 27 resulting in a commensurate reduction in power on each branch.

Upon entering the amplifier section 20, each amplifier 30 may be appropriately doped, for example, with erbium ions to form an erbium-doped waveguide amplifier. The erbium ions are resonant with the wavelength of the pump 22 signal and the wavelength of the input optical signals 12. The erbium ions (indicated by slashes on the amplifiers 30) release energy stored from the pump 22 signal to the split components of the input optical signal 12, increasing the power of the input optical signal components while decreasing the power of the split pump signal. The erbium ions, embedded within the amplifier 30 core, may act as non-linear elements to achieve power transfer.

As a result of the combination of the pump and input optical signals, before splitting, better performance may be achieved in the splitter 26, in some embodiments, due to the reduction or elimination of fiber interface losses and propagation losses in extra waveguides. Smaller sizes and easier packaging, together with improved manufacturing, may result in lower costs in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving an input optical signal;
receiving a pump signal; and
combining said pump and input optical signals; and
splitting said combined signals.

2. The method of claim 1 including directionally coupling a pump signal to the received optical signal before splitting said received optical signal.

3. The method of claim 1 including using a waveguide splitter to split said combined signals.

4. The method of claim 1 including a waveguide directional coupler to couple said pump signal to said input optical signal.

5. The method of claim 1 including coupling an amplifier to said splitter to amplify said split combined signals.

6. A splitter comprising:
a combiner to combine a pump signal and an input optical signal; and
a splitter section to split the combined signal.

7. The splitter of claim 6 including an optical amplifier coupled to receive the split signal from said splitter section.

8. The splitter of claim 6 wherein said combiner includes a directional coupler.

9. The splitter of claim 6 wherein said splitter is a waveguide.

10. The splitter of claim 6 wherein said combiner includes a waveguide.

11. The splitter of claim 10 including an integrated waveguide.

12. The splitter of claim 7 including an erbium doped waveguide amplifier.

13. A splitter comprising:
a combiner to combine a pump signal and an input optical signal;
a splitter section to split the combined optical signal to form split signals; and
an optical amplifier coupled to receive the split signals from said splitter section.

14. The splitter of claim 13 wherein said combiner is a directional coupler.

15. The splitter of claim 13 wherein said splitter is a waveguide.

16. The splitter of claim 15 including an integrated waveguide.

17. The splitter of claim 16 wherein said waveguide is erbium doped.

18. The splitter of claim 13 wherein said amplifier and said splitter section are separate parts.

19. The splitter of claim 13 wherein said splitter is a passive optical splitter.

20. The splitter of claim 13 wherein said splitter section includes branched waveguides.
